(19) United States
(12) Patent Application Publication
(10) Pub. No.: US 2014/0125173 A1
(43) Pub. Date: May 8, 2014

(54) ROTATING ELECTRIC MACHINE

(71) Applicant: Denso Corporation, Kariya-city (JP)

(72) Inventor: Jirou HAYASHI, Ama-city (JP)

(73) Assignee: DENSO CORPORATION, Kariya-city (JP)

(21) Appl. No.: 14/071,769

(22) Filed: Nov. 5, 2013

(30) Foreign Application Priority Data
Nov. 5, 2012 (JP) 2012-243530

(51) Int. Cl. H02K 5/10

(52) U.S. Cl. CPC H02K 5/10
USPC 310/88

(57) ABSTRACT

The rotating electric machine has a motor case, a stator, a winding wire, a wire extension, a rotor, a shaft, a first plate, a second plate, a control unit, and a tubular bush. The first plate seals a first end of the motor case and supports a first end of the shaft. The second plate seals a second end of the motor case, supports a second end of the shaft, and has a through-hole. The control unit is positioned on an opposite side of the second plate that is opposite to the motor case. The control unit is connected with the wire extension to control electricity supplied to the winding wire. The tubular bush is disposed inside the through-hole, or is disposed outside the through-hole between the winging wire and the second plate.

### CROSS REFERENCE TO RELATED APPLICATION

This application is based on Japanese Patent Application No. 2012-243530 filed on Nov. 5, 2012, the disclosure of which is incorporated herein by reference in its entirety.

### TECHNICAL FIELD

The present disclosure relates to a rotating electric machine.

### BACKGROUND

Conventionally, a rotating electric machine has a motor case having a tubular shape and a control unit controlling energization of a winding wire. The motor case has a plate sealing an end of the motor case, and the control unit is positioned on an opposite side of the plate that is opposite to the motor case. For example, JP-2011-10408A (corresponding to U.S. Pat. No. 8,299,664 B2) discloses a rotating electric machine in which a winding wire and a control unit are electrically coupled with each other by a wire extension. A plate sealing an end of a motor case has a through-hole, and the wire extension is inserted in the through-hole.

According to the rotating electric machine disclosed in JP-2011-10408A, a clearance is defined between the wire extension and the through-hole so that the wire extension and the plate are insulated from each other. However, when the rotating electric machine is positioned in an environment in which, for example, the rotating electric machine is shaken, the wire extension may touch an inner surface of the through-hole, and current may flow from the wire extension to the plate.

Further, a foreign particle may enter the motor case through the clearance defined between the wire extension and the plate from a side adjacent to the control unit. In this case, the foreign particle may be stuck between a rotor and a portion constructing the rotating electric machine, and the rotor may stop rotating.

### SUMMARY

According to an example of the present disclosure, there is provided a rotating electric machine in which a foreign particle is restricted from entering a motor case while a wire extension is insulated from a metal component.

According to the present disclosure, the rotating electric machine has: a motor case having a tubular shape; a stator disposed in the motor case; a winding wire wound around the stator; a wire extension disposed to extend from the winding wire; a rotor disposed in the stator to be rotatable; a shaft disposed to pass through a rotation axis of the rotor; a first plate sealing a first end of the motor case and supporting a first end of the shaft; a second plate sealing a second end of the motor case, supporting a second end of the shaft, and having a through-hole through which the wire extension passes, the second plate being made of metal; a control unit positioned on an opposite side of the second plate that is opposite to the motor case; and a tubular bush made of an insulating material. The control unit is connected with the wire extension to control electricity supplied to the winding wire. The wire extension passes through the tubular bush. The tubular bush is disposed inside the through-hole to be in contact with an inner surface of the through-hole, or is disposed outside the through-hole between the winging wire and the second plate such that a first end of the tubular bush is in contact with the winding wire and that a second end of the tubular bush is in contact with the second plate around the through-hole.

By disposing the tubular bush made of the insulating material between the wire extension and the second plate, the wire extension and the second plate are electrically separated from each other. Further, by disposing the tubular bush between the wire extension and the second plate, an aperture defined between the inner surface of the through-hole and the wire extension is closed. Therefore, a foreign particle is restricted from entering the motor case through the aperture from a side adjacent to the control unit.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a cross-sectional view illustrating a rotating electric machine according to a first embodiment;

FIG. 2A is a front view illustrating a tubular bush of the rotating electric machine according to the first embodiment;

FIG. 2B is a view illustrating the tubular bush viewed from a direction IIB of FIG. 2A;

FIG. 2C is a view illustrating the tubular bush viewed from a direction IIC of FIG. 2A;

FIG. 2D is a cross-sectional view taken along a line IID-IID of FIG. 2B;

FIG. 2E is a cross-sectional view taken along a line IIE-IIE of FIG. 2B;

FIG. 2F is a perspective view illustrating the tubular bush;

FIG. 2G is a perspective view illustrating the tubular bush;

FIG. 3A is a perspective view showing how to dispose the tubular bush according to the first embodiment;

FIG. 3B is a perspective view showing how to dispose a second plate according to the first embodiment;

FIG. 3C is a perspective view showing how to dispose a control unit according to the first embodiment;

FIG. 3D is a cross-sectional view illustrating the rotating electric machine after the second end plate is disposed;

FIG. 4A is a partial-cross-sectional view illustrating a rotating electric machine according to a second embodiment;

FIG. 4B is a cross-sectional view illustrating a tubular bush of the rotating electric machine according to the second embodiment; and

FIG. 4C is a view illustrating the tubular bush viewed from a direction IVC of FIG. 4B.

### DETAILED DESCRIPTION

Embodiments of the present disclosure will be described hereafter referring to drawings. In the embodiments, a part that corresponds to a matter described in a preceding embodiment may be assigned with the same reference number, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

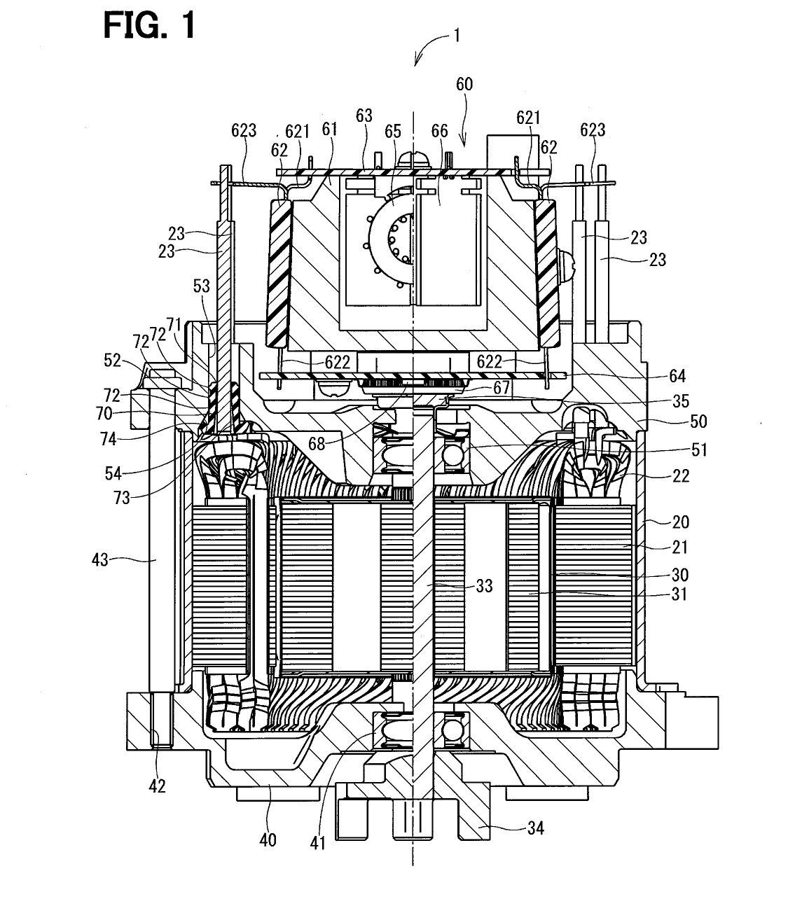

A rotating electric machine 1 according to a first embodiment is shown in FIG. 1. The rotating electric machine 1 is activated by electric power. For example, the rotating electric machine 1 is used as a drive part to drive an electric-power-steering assisting a steering operation of a vehicle. The rotating electric machine 1 may be a three-phase brushless-motor.

The rotating electric machine 1 includes a motor case 20, a stator 21, a winding wire 22, a wire extension 23, a rotor 30, a shaft 33, a first plate 40, a second plate 50, a control unit 60, and a tubular bush 70.

The motor case 20 is made by a material such as metal to have a tubular shape. The motor case 20 includes a first end on a side adjacent to the first plate 40 and a second end on a side adjacent to the second plate 50.

The stator 21 is made of, for example, thin metal plates laminated to have a generally annular shape. The stator 21 is disposed in the motor case 20 to be unrotatable relative to the motor case 20 so that an outer wall of the stator 21 is in contact with an inner wall of the motor case 20.

The winding wire 22 is made by metal such as copper and winds around the stator 21. The winding wire 22 defines two pairs of winding wire portions, and each of the two pairs of winding wire portions produces three phases.

Similar to the winding wire 22, the wire extension 23 is made by metal such as copper. The wire extension 23 is disposed to extend from the winding wire 22 so that the wire extension 23 is generally parallel to a rotation axis, for example, an axis of the stator 21. The wire extension 23 includes a first end connected to the winding wire 22 and a second side opposite to the first end in the axial direction. According to the first embodiment, the first end of the wire extension 23 and the winding wire 22 are joined with each other by a method such as welding. According to the first embodiment, six of the wire extensions 23 are disposed to correspond to the six phases produced by the two pairs of winding wire portions.

The rotor 30 has a rotor core 31. The rotor core 31 is formed by, for example, laminating thin metal plates to have a generally cylindrical shape. The rotor core 31 is disposed in the stator 21 so that an outer wall of the rotor core 31 faces an inner wall of the stator 21.

The shaft 33 is made of a material such as metal to have a rod shape and is disposed to a center of the rotor core 31 so that the shaft 33 passes through a rotation axis.

The first plate 40 has a plate shape and seals the first end of the motor case 20. The first plate 40 includes a bearing 41 at a center of the first plate 40. The bearing 41 supports a first end of the shaft 33. The first plate 40 includes an outer periphery having a bolt hole 42.

The second plate 50 has a plate shape and seals the second end of the motor case 20. The second plate 50 includes a bearing 51 at a center of the second plate 50. The bearing 51 supports a second end of the shaft 33. That is, the shaft 33 is supported by the bearing 41 and the bearing 51. Therefore, the rotor 30 rotates integrally with the shaft 33 inside the stator 21. Thus, the shaft 33 is positioned at the rotation axis of the rotor 30 so that an axis of the shaft 33 is parallel to the rotation axis of the rotor 30.

The second plate 50 has an outer periphery having a bolt hole 52. A through-bolt 43 is disposed so that a first end of the through-bolt 43 is tighten to the bolt hole 42 of the first plate 41 and that a second end of the through-bolt 43 is held by the bolt hole 52. Therefore, the first plate 40 and the second plate 50 are fixed so that the motor case 20 is positioned between the first plate 40 and the second plate 50. According to the first embodiment, the first plate 40 and the second plate 50 are coupled and tighten with each other by a plurality of the through-bolts 43.

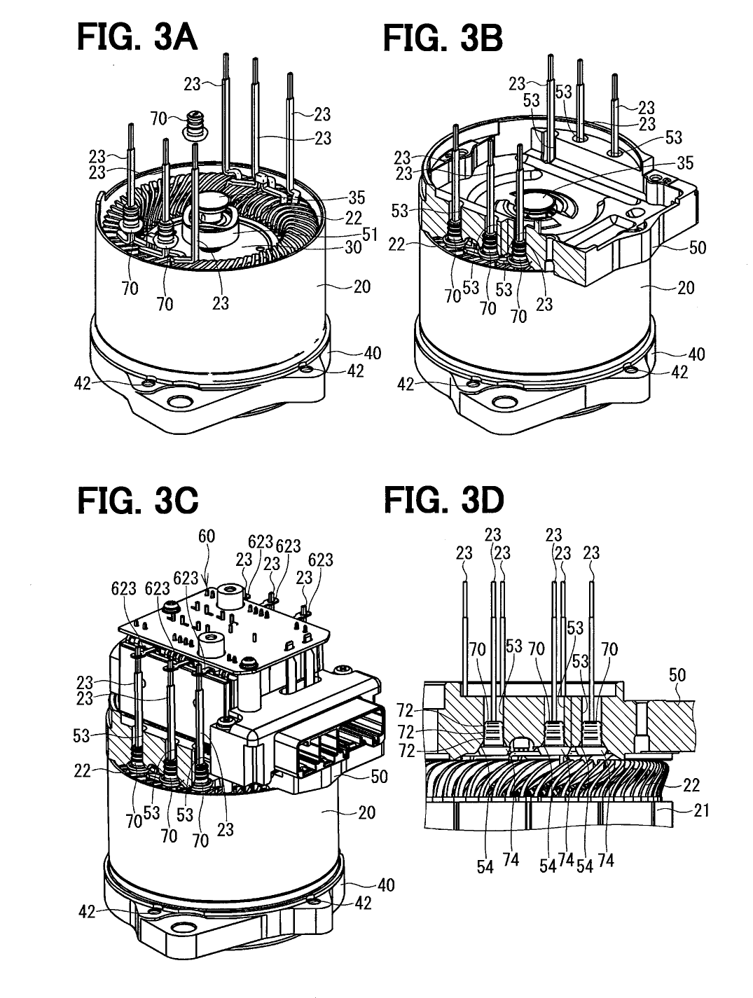

As shown in FIGS. 1 and 3B, the second plate 50 includes a through-hole 53 passing through the second plate 50 in a thickness direction of the second plate 50. For example, the second plate 50 has six of the through-holes 53. The wire extension 23 is inserted to each of the six of the through-holes 53.

The control unit 60 is disposed on an opposite side of the second plate 50 that is opposite to the motor case 20. The control unit 60 includes a heatsink 61, a semiconductor package 62, a power substrate 63, a control substrate 64, a choke coil 65, a capacitor 66, a microcomputer 67, and a hole integrated circuit (a hole IC) 68.

The heatsink 61 is made by metal such as aluminum to have a block shape.

The semiconductor package 62 is disposed in contact with an outer wall of the heatsink 61. According to the first embodiment, two of the semiconductor packages 62 are disposed to oppose each other through the heatsink 61 in a radial direction of the rotor 30. The semiconductor package 62 has a switching element (not shown) inside. According to the first embodiment, each of the two of the semiconductor packages 62 has six switching elements. Further, the semiconductor package 62 includes a terminal 621, a terminal 622, and a terminal 623 electrically coupled with the corresponding switching element. When the semiconductor package 62 is actuated, the semiconductor package 62 generates heat. The heat is dissipated via the heatsink 61.

The power substrate 63 is positioned on an opposite side of the heatsink 61 that is opposite to the second plate 50. The control substrate 64 is positioned between the heatsink 61 and the second plate 50.

The terminal 621 of the semiconductor package 62 connects to the power substrate 63. The terminal 622 connects to the control substrate 64. The choke coil 65 and the capacitor 66 connect to the power substrate 63 and are disposed in a space defined by the heatsink 61 and the power substrate 63. The choke coil 65 and the capacitor 66 reduce ripple current flowing through the semiconductor package 62 and noises.

The microcomputer 67 is positioned on an opposite side of the control substrate 64 that is opposite to the heatsink 61. The microcomputer 67 controls actuation of the switching element of the semiconductor package 62 via the terminal 622. The terminal 623 of the semiconductor package 62 is coupled with a second end of the wire extension 23, which is opposite from the first end of the wire extension 23 connected to the winding wire 22.

The hole IC 68 is coaxially positioned with the shaft 33 on an opposite side of the control substrate 64 that is opposite to the heatsink 61. The hole IC 68 has a magnetic detecting device (not shown) inside. The hole IC 68 applies a signal to the microcomputer 67 based on a direction of a magnetic flux produced around the hole IC 68.

By controlling actuation of the switching element of the semiconductor package 62, current flows in the winding wire 22 via the terminal 621, the terminal 623, and the wire extension 23. Accordingly, a rotating magnetic field is produced at the stator 21, and the rotor 30 rotates based on the rotating magnetic field.

An output part 34 is disposed to the first end of the shaft 33 supported by the bearing 41 of the first plate 40. The output part 34 outputs the rotation as power of the rotating electric machine 1.

A magnet 35 is disposed to the second end of the shaft 33, which is opposite to the first end of the shaft 33 having the output part 34. When the magnet 35 and the shaft 33 rotate integrally, the hole IC 68 outputs a signal to the microcomputer 67 based on a rotation angle of the shaft 33, in other words, a rotation angle of the rotor 30. The microcomputer 67 controls actuation of the semiconductor package 62 while the microcomputer 67 detects the rotation angle of the rotor 30 based on a signal fed from the hole IC 68.

A cover portion (not shown) is disposed on an opposite side of the second plate 50 that is opposite to the motor case 20 such that the cover portion covers the control unit 60. That is, the control unit 60 is positioned in the cover portion. Accordingly, the second plate 50 is disposed to separate a motor area including the stator 21 and the rotor 30 from a controlling area including the control unit 60.

The tubular bush 70 is made of an insulating material such as rubber to have a tubular shape. The tubular bush 70 has an elastic modulus which is smaller than or equal to a predetermined value.

As shown in FIG. 1, the tubular bush 70 is disposed in the through-hole 53 so that an outer wall of the tubular bush 70 in a radial direction touches an inner wall of the through-hole 53 in a condition that the wire extension 23 is inserted in the tubular bush 70. According to the first embodiment, six of the tubular bushes 70 are disposed to correspond to the six of the wire extensions 23.

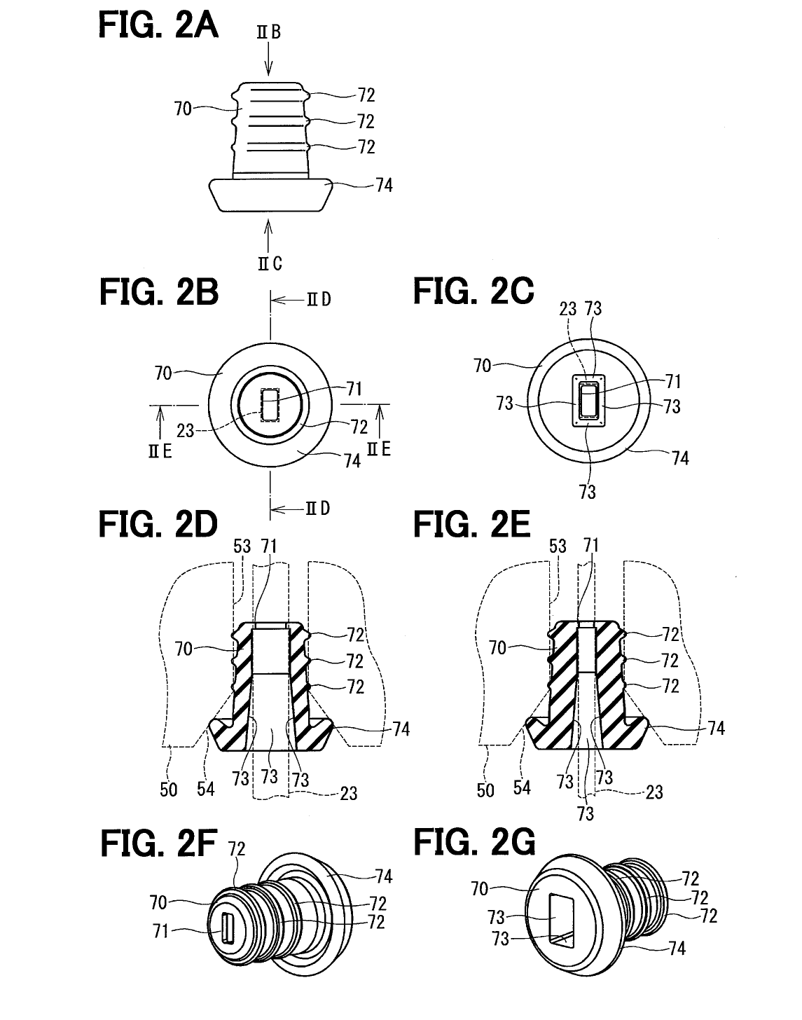

As shown in FIGS. 2B-2E, the tubular bush 70 has an inner wall including an inner projection 71. The inner projection 71 makes the inner open area of the tubular bush 70 to be smaller than a cross-sectional area of the wire extension 23 before the wire extension 23 is inserted in the tubular bush 70. As shown in FIGS. 2B, 2C, and 3A-3D, the wire extension 23 has a rectangular-wire shape having a rectangle cross-section. As shown in FIGS. 2B and 2C, an opening defined by the inner projection 71 has a rectangle shape. That is, in comparison of cross-sectional shapes, a longitudinal length of the opening defined by the inner projection 71 is shorter than a longitudinal length of the wire extension 23 before the wire extension 23 is inserted in the tubular bush 70. Further, in comparison of cross-sectional shapes, a lateral length of the opening defined by the inner projection 71 is shorter than a lateral length of the wire extension 23 before the wire extension 23 is inserted in the tubular bush 70. Accordingly, when the wire extension 23 is inserted in the tubular bush 70, in other words, inserted into the opening defined by the inner projection 71, the inner projection 71 deforms elastically and fits tightly to the wire extension 23 along all outer periphery of the wire extension 23.

As shown in FIGS. 2D and 2E, the outer wall of the tubular bush 70 includes an outer projection 72 having an annular shape. The tubular bush 70 is defined so that an outside diameter of the tubular bush 70 is larger than a minimum inside diameter of the through-hole 53 before the tubular bush 70 is inserted into the through-hole 53. According to the first embodiment, the outer wall of the tubular bush 70 includes three of the outer projections 72. As shown in FIG. 2A, an outside diameter of the tubular bush 70 gradually becomes smaller from the first end to the second end in the axial direction. The three of the outer projections 72 have generally the same outside diameter. Accordingly, when the tubular bush 70 is inserted in the through-hole 53, the outer projection 72 deforms elastically and fits tightly to the inner surface of the through-hole 53 along all outer periphery of the through-hole 53.

As shown in FIGS. 2D and 2E, the tubular bush 70 has an inner sloped surface 73 inclined relative to the axis. A distance from the axis to the inner sloped surface 73 is made to become smaller from the first end to the second end. The inner sloped surface 73 has a flat shape, and the inner wall of the tubular bush 70 has four of the inner sloped surfaces 73 at the first end.

As shown in FIGS. 1, 2D and 2E, the through-hole 53 of the second plate 50 has an inner sloped surface 54 inclined relative to an axis of the through-hole 53. According to the first embodiment, a distance from the axis to the inner sloped surface 54 becomes longer as approaching the winding wire 22. The inner sloped surface 54 has a taper shape as a part of the through-hole 53 on the first end adjacent to the winding wire 22.

Further, as shown in FIGS. 2A-2G, the tubular bush 70 has a flange portion 74 on the first end, and the flange portion 74 has an annular shape protruding outwardly in the radial direction.

As shown in FIGS. 1 and 3D, the tubular bush 70 is disposed in the through-hole 53 so that the flange portion 74 is in contact with the inner sloped surface 54 or a surface of the second plate 50 adjacent to the winding wire 22. Therefore, the tubular bush 70 is restricted from moving away from the winding wire 22 with respect to the second plate 50.

Assembly of the rotating electric machine 1 according to the first embodiment will be described hereafter with reference to FIGS. 3A-3D.

As shown in FIG. 3A, the tubular bush 70 is disposed to the corresponding wire extension 23 such that the wire extension 23 is inserted in the tubular bush 70. The tubular bush 70 is disposed to each of the six of the wire extensions 23.

As shown in FIG. 3B, the second plate 50 is disposed to the motor case 20 so that the wire extension 23 is inserted in the through-hole 53, and that the tubular bush 70 is fitted with the through-hole 53.

As shown in FIG. 3C, the control unit 60 is disposed on the second plate 50 to be located opposite from the motor case 20. The terminal 623 of the semiconductor package 62 is connected to an end of the wire extension 23 opposite from the winding wire 22 by a method such as welding.

As discussed above, according to the first embodiment, the tubular bush 70 made of an insulating material is positioned between the wire extension 23 and the second plate 50. Therefore, the wire extension 23 and the second plate 50 are electrically insulated from each other.

By disposing the tubular bush 70 between the wire extension 23 and the second plate 50, a clearance generated between the inner surface of the through-hole 53 and the wire extension 23 is closed. Therefore, a foreign particle is restricted from entering the motor case 20 through the clearance from the controlling area including the control unit 60 to the motor area including the rotor 30. Accordingly, an abnormality, in which, for example, the rotor 30 is stopped rotating by the foreign particle coming from the controlling area via the clearance, can be prevented.

According to the first embodiment, the tubular bush 70 has the elastic modulus smaller than or equal to the predetermined value. Therefore, when the tubular bush 70 is inserted in the through-hole 53, the outer wall of the tubular bush 70 is deformed elastically, so the tubular bush 70 and the inner wall of the through-hole 53 tightly fit with each other. Accordingly, the clearance or gap defined between the tubular bush 70 and the inner wall of the through-hole 53 is certainly closed. Moreover, since the tubular bush 70 has the elastic modulus smaller than or equal to the predetermined value, the tubular bush 70 can absorb vibration of the wire extension 23.

According to the first embodiment, the inner wall of the tubular bush 70 includes the inner projection 71. Due to the inner projection 71, the opening cross-sectional area is made smaller than the cross-sectional area of the wire extension 23 before the wire extension 23 is inserted in the tubular bush 70. Therefore, when the wire extension 23 is inserted in the tubular bush 70, in other words, inserted into the opening surrounded by the inner projection 71, the inner projection 71 deforms elastically and fits tightly to the wire extension 23 along all outer periphery of the wire extension 23. Accordingly, the clearance between the tubular bush 70 and the wire extension 23 is certainly closed.

According to the first embodiment, the outer wall of the tubular bush 70 includes the outer projection 72 having the annular shape. The outside diameter of the tubular bush 70 is made lager than the minimum inside diameter of the through-hole 53 before the tubular bush 70 is inserted into the through-hole 53. Therefore, when the tubular bush 70 is inserted in the through-hole 53, the outer projection 72 is deformed elastically and fits tightly to the inner surface of the through-hole 53 along all outer periphery of the through-hole 53. Accordingly, the clearance between the tubular bush 70 and the inner surface of the through-hole 53 is certainly closed.

According to the first embodiment, the tubular bush 70 has the inner sloped surface 73 inclined relative to the axis. Therefore, when the wire extension 23 is inserted into the tubular bush 70, the end of the wire extension 23 can be guided by the inner sloped surface 73. Thus, the wire extension 23 can be easily inserted into the tubular bush 70.

According to the first embodiment, the through-hole 53 of the second plate 50 has the inner sloped surface 54 inclined relative to the axis of the through-hole 53. Therefore, when the wire extension 23 is inserted in the through-hole 53, the inner sloped surface 54 can guide the second end of the wire extension 23. Further, when the tubular bush 70 is joined to the through-hole 53, the inner sloped surface 54 can lead the second end of the tubular bush 70. Accordingly, the wire extension 23 is inserted easily in the through-hole 53, and the tubular bush 70 is joined easily to the through-hole 53.

According to the first embodiment, the tubular bush 70 has the flange portion 74, and the flange portion 74 has an annular shape protruding outwardly in the radial direction. The tubular bush 70 is disposed in the through-hole 53 so that the flange portion 74 touches the inner sloped surface 54 or the surface of the second plate 50 adjacent to the winding wire 22. Therefore, the tubular bush 70 is restricted from moving away from the winding wire 22 with respect to the second plate 50.

### Second Embodiment

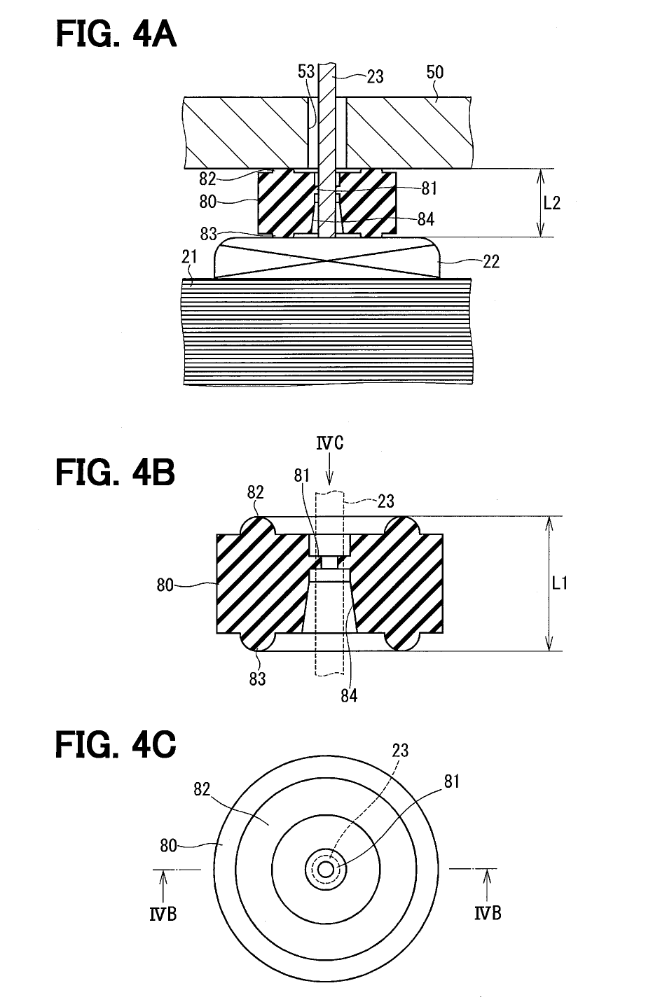

A rotating electric machine according to a second embodiment is described with reference to FIGS. 4A-4C. For example, a tubular bush 80 according to the second embodiment is different from the tubular bush 70 of the first embodiment.

According to the second embodiment, the tubular bush 80 is made of an insulating material such as rubber. Further, the tubular bush 80 has an elastic modulus which is smaller than or equal to a determined value.

As shown in FIG. 4A, the tubular bush 80 is positioned outside the through-hole 53 of the second plate 50 in the state where the wire extension 23 passes through the tubular bush 80. A first end of the tubular bush 80 is in contact with the winding wire 22, and a second end of the tubular bush 80 is in contact with the second plate 50 around the through-hole 53. That is, the tubular bush 80 is disposed between the winding wire 22 and the second plate 50.

As shown in FIGS. 4B and 4C, the tubular bush 80 has an inner wall including an inner projection 81. The opening surrounded by the inner projection 81 has an opening area which is smaller than a cross-sectional area of the wire extension 23 before the wire extension 23 is inserted in the tubular bush 80. That is, an interference is defined by a difference between the diameter of the opening surrounded by the inner projection 81 and the diameter of the wire extension 23.

As shown in FIG. 4C, according to the second embodiment, the wire extension 23 has a circular shape in cross-sectional taken along a line perpendicular to the axis. Further, as shown in FIG. 4C, the opening surrounded by the inner projection 81 has a circular shape. That is, an inside diameter of the opening of the inner projection 81 is smaller than an outside diameter of the wire extension 23 before the wire extension 23 is disposed inside the tubular bush 80. Accordingly, when the wire extension 23 is inserted in the tubular bush 80, in other words, inserted into the opening of the inner projection 81, the inner projection 81 is deformed elastically and fits tightly to all around the wire extension 23.

As discussed above, the tubular bush 80 is disposed outside the through-hole 53 so that the first end of the tubular bush 80 touches the winding wire 22, and that the second end of the tubular bush 80 touches around the opening of the through-hole 53, as shown in FIG. 4A. As shown in FIG. 4B, the tubular bush 80 has an axial projection 82 and an axial projection 83 protruding in the axial direction so that the tubular bush 80 has an axial length L1 in the axial direction before the tubular bush 80 is disposed outside the through-hole 53. The axial length L1 is larger than a distance L2 between the second plate 50 and the winding wire 22.

According to the second embodiment, the axial projection 82 is defined to extend from the second end of the tubular bush 80 in the axial direction and has a generally annular shape in cross-section taken along a line perpendicular to the axis. The axial projection 83 is defined to extend from the first end of the tubular bush 80 in the axial direction and has a generally annular shape in cross-section taken along a line perpendicular to the axis. Accordingly, when the tubular bush 80 is disposed outside the through-hole 53 between the second plate 50 and the winding wire 22, the axial projection 82 and the axial projection 83 are deformed elastically. Further, the axial projection 82 fits tightly with the second plate 50 around the through-hole 53 along all outer periphery on a side adjacent to the winding wire 22, and the axial projection 83 fits tightly with the winding wire 22.

As shown in FIGS. 4A and 4B, the tubular bush 80 has an inner sloped surface 84 inclined relative to the axis. A distance from the axis to the inner sloped surface 84 is made smaller from the first end to the second end of the tubular bush 80. The inner sloped surface 84 has a taper shape on a side of the tubular bush 80 adjacent to the winding wire 22.

As discussed above, similar to the first embodiment, the tubular bush 80 made of an insulating material is positioned between the wire extension 23 and the second plate 50. Therefore, the wire extension 23 and the second plate 50 are electrically insulated from each other.

Moreover, by disposing the tubular bush 80 between the wire extension 23 and the second plate 50, an aperture defined between the wire extension 23 and the through-hole 53 is closed. Therefore, a foreign particle is restricted from entering the aperture from the controlling area including the control unit 60 to the motor area including the rotor 30. Accordingly, an abnormality, in which, for example, the rotor 30 is stopped rotating by the foreign particle, can be prevented.

According to the second embodiment, the tubular bush 80 has the elastic modulus which is smaller than or equal to the predetermined value. When the tubular bush 80 is disposed outside the through-hole 53 between the winding wire 22 and the second plate 50, the outer wall of the tubular bush 80 is deformed elastically. Therefore, the tubular bush 80 tightly fits around a periphery of the through-hole 53. Accordingly, an aperture defined between the tubular bush 80 and the through-hole 53 is certainly closed. Further, by forming the tubular bush 80 to have the elastic modulus which is smaller than or equal to the predetermined value, the tubular bush 80 can absorb vibration of the wire extension 23.

According to the second embodiment, the inner wall of the tubular bush 80 has the inner projection 81. The opening defined by the inner projection 81 has an opening area which is smaller than a cross-sectional area of the wire extension 23 before the wire extension 23 is inserted in the tubular bush 80. Accordingly, when the wire extension 23 is inserted in the tubular bush 80, in other words, inserted into the opening of the inner projection 81, the inner projection 81 is deformed elastically and fits tightly to all around a periphery of the wire extension 23. Therefore, an aperture defined between the tubular bush 80 and the wire extension 23 is certainly closed.

The tubular bush 80 has the axial projection 82 and the axial projection 83 so that the length L1 of the tubular bush 80 in the axial direction is larger than the distance L2 between the second plate 50 and the winding wire 22 before the tubular bush 80 is disposed between the second plate 50 and the winding wire 22. Accordingly, when the tubular bush 80 is disposed outside the through-hole 53 between the second plate 50 and the winding wire 22, the axial projection 82 and the axial projection 83 are deformed elastically. Accordingly, the axial projection 82 tightly fits to the second plate 50 all around the through-hole 53 and the axial projection 83 tightly fits to the winding wire 22. Therefore, an aperture defined between the tubular bush 80 and the second plate 50 around the through-hole 53 is certainly closed, and an aperture defined between the tubular bush 80 and the winding wire 22 is certainly closed.

According to the second embodiment, the tubular bush 80 has the inner sloped surface 84 inclined relative to the axis. When the wire extension 23 is inserted in the tubular bush 80, the inner sloped surface 84 leads the end of the wire extension 23. Thus, the wire extension 23 can be easily inserted into the tubular bush 80.

### Other Modifications

The tubular bush may have an elastic modulus which is bigger than the predetermined value. Further, the tubular bush is not limited to be made of rubber, and the tubular bush may be made of a material such as polyvinyl chloride (PVC) and silicon resin. In short, a material making the tubular bush is not limited, so far as the material is an insulating material.

Although the tubular bush has an inner wall including one inner projection according to above embodiments, the inner wall may include plural inner projections. Alternatively, the inner wall may include no inner projection.

According to the first embodiment, the outer wall of the tubular bush has three outer projections. However, the number of the outer projections is not limited to three, or the tubular bush may have no outer projection.

According to the second embodiment, the tubular bush has two axial projections. Alternatively, the tubular bush may have the axial projection at only one end in the axial direction, or the tubular bush may have no axial projection.

Further, the tubular bush may have no flange portion.

According to the above embodiments, the inner wall of the tubular bush includes the sloped surface inclined relative to the axis. Alternatively, the tubular bush may have no sloped surface.

According to the first embodiment, the second plate has the through-hole, and the inner surface of the through-hole includes the inner sloped surface inclined to the axis of the through-hole. Alternatively, the second plate may have no sloped surface.

According to the first embodiment, the wire extension has the rectangle shape in cross-section. Alternatively, the wire extension may have a circular shape in cross-section. In this case, the opening defined by the inner projection of the tubular bush may have a circular shape.

According to the second embodiment, the wire extension has the circular shape in cross-section. Alternatively, the wire extension may have a rectangle shape in cross-section. In this case, the opening defined by the inner projection of the tubular bush may have a rectangle shape in cross-section.

That is, the cross-sectional shape of the wire extension is not limited, and the wire extension may have the cross-sectional shape corresponding to the shape of the opening of the tubular bush.

According to the above embodiments, the wire extension is made separately from the winding wire. Alternatively, the wire extension may be made integrally with the winding wire to extend from the winding wire.

According to the above embodiments, both the first plate and the second plate are made separately from the motor case. Alternatively, at least one of the first plate and the second plate may be made integrally with the motor case.

According to the first embodiment, in the assembly of the rotating electric machine, after the tubular bush is disposed to the wire extension, the second plate is disposed to the motor case. Alternatively, the second plate may be joined to the motor case in a manner that the wire extension pass through the tubular bush after the tubular bush is joined to the through-hole of the second plate.

The tubular bush may be formed by filling a material having viscosity which is smaller than or equal to a predetermined value into a space defined between the inner surface of the through-hole and the wire extension.

For example, the tubular bush may be made of a material such as thermoplastic resin. By heating the material, viscosity of the material is reduced to have a value which is smaller than or equal to the predetermined value, so as to secure a predetermined fluidity. While the fluidity is maintained, the material fills the space, and is hardened by cooling.

For example, the tubular bush may be made of a material such as thermosetting resin. While viscosity of the material is smaller than or equal to a predetermined degree, the material fills the space, and is hardened by heating.

For example, the tubular bush may be made of a material such as photo-curing resin. While viscosity of the material is smaller than or equal to a predetermined degree, the material fills the space, and is hardened by light irradiation.

The rotating electric machine 1 according to the present disclosure is not limited to be employed as a drive part for the electric power steering device, and may be employed to drive other devices.

Such changes and modifications are to be understood as being within the scope of the present disclosure as defined by the appended claims.

What is claimed is:

1. A rotating electric machine, comprising:
a motor case having a tubular shape;
a stator disposed in the motor case;
a winding wire wound around the stator;
a wire extension disposed to extend from the winding wire;
a rotor disposed in the stator to be rotatable;
a shaft disposed to pass through a rotation axis of the rotor;
a first plate sealing a first end of the motor case and supporting a first end of the shaft;
a second plate sealing a second end of the motor case, supporting a second end of the shaft, and having a through-hole through which the wire extension passes, the second plate being made of metal;
a control unit positioned on an opposite side of the second plate that is opposite to the motor case, wherein the control unit is connected with the wire extension to control electricity supplied to the winding wire; and
a tubular bush made of an insulating material, wherein the wire extension passes through the tubular bush, wherein
the tubular bush is disposed inside the through-hole to be in contact with an inner surface of the through-hole, or is disposed outside the through-hole between the winging wire and the second plate such that a first end of the tubular bush is in contact with the winding wire and that a second end of the tubular bush is in contact with the second plate around the through-hole.

2. The rotating electric machine according to claim 1, wherein
the tubular bush has an elastic modulus of which value is smaller than or equal to a predetermined value.

3. The rotating electric machine according to claim 1, wherein
the tubular bush has an inner projection projected from an inner surface of the tubular bush so that an inner open area of the tubular bush is smaller than a cross-sectional area of the wire extension before the wire extension is inserted in the tubular bush.

4. The rotating electric machine according to claim 1, wherein
the tubular bush has an outer projection projected from an outer surface of the tubular bush so that an outside diameter of the tubular bush is larger than a minimum inside diameter of the through-hole before the tubular bush is inserted in the through-hole.

5. The rotating electric machine according to claim 1, wherein
the tubular bush has an axial projection projected from an axial end of the tubular bush so that a length of the tubular bush in an axial direction is larger than a distance between the second plate and the winding wire before the tubular bush is disposed outside the through-hole between the winging wire and the second plate.

6. The rotating electric machine according to claim 1, wherein
the tubular bush has an inner sloped surface which is inclined relative to an axis of the tubular bush.

7. The rotating electric machine according to claim 1, wherein
the through-hole of the second plate has an inner sloped surface which is inclined relative to an axis of the through-hole.

8. The rotating electric machine according to claim 1, wherein
the tubular bush is formed by filling a material to a space defined between the inner surface of the through-hole and the wire extension when a viscosity of the material is smaller than or equal to a predetermined value.
